(19) United States
(12) Patent Application Publication
(10) Pub. No.: US 2010/0162275 A1
(43) Pub. Date: Jun. 24, 2010

(54) CONTROLLING APPLICATIONS THROUGH INTER-PROCESS COMMUNICATION

(75) Inventors: Quetzalcoatl Bradley, Monroe, WA (US); Lui Lui Wong, Seattle, WA (US); Douglas A. Walter, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation Way, Redmond, WA (US)

(21) Appl. No.: 12/340,045

(22) Filed: Dec. 19, 2008

(51) Int. Cl. G06F 3/00; G06F 9/44; G06F 9/46

(52) U.S. Cl. 719/328

(57) ABSTRACT

The present invention extends to methods, systems, and computer program products for controlling applications through inter-process communication. Applications are extended with application specific extensibility points. The application specific extensibility points permit applications that natively lack inter-process communication capabilities to participate in inter-process communication. Application specific extensibility points can provide an application with a Web based interface thereby making the functionality of the application available to other Web services and other extended applications. Accordingly, application specific extensibility points extend the functionality of applications to interoperate and be integrated with other Web services and other extended applications. In some embodiments, specific extensibility points are used to programmatically test application functionality that can otherwise only be activated through interaction with an application's user-interface

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

Many applications have a user interface that permits users to interact with the application and access the applications functionality. A user interface receives user input from input devices, such as, for example, a mouse and keyboard. For example, a user-interface for an operating system can permit users to select items, drag and drops, deselect items, etc. Based on received user input, the user interface can call underlying application components to perform various processing operations. For example, an operating system can move files, delete files, change system settings, etc. When the underlay application components complete operations they can return results of the processing operations to the user interface. For example, an operating system can return the updated contents of a directory to the user interface. The user interface can then reflect the results of the processing to the user at one or more output devices, such as, for example, a video display and speakers.

Many applications include extensibility points that permit the functionality of the applications to be extended through post-release code development. For example, many applications permit users or third-party developers to generate add-ins or plug-ins to extend application functionality. Similarly, to the native functionality of an application, extended functionality is often invoked and the results presented at a user-interface. Advantageously, most applications provide users with flexible control of both native and extended application functionality through a user interface.

However, in some operating environments, invoking and presenting the results of application functionality at a user interface is inefficient and costly. For example, application testing can require that an application be tested against a large number of different inputs. The inputs are used to determine if the application operates as intended under different conditions.

To some extent automated testing mechanisms can be used to test application functionality. For example, a testing program can load sets of input data from a file and submit the sets individually to parts of an application to determine how the application reacts. Unfortunately, automated mechanisms typically have limited usefulness for testing application functionality that is invoked through user as interaction with a user interface. The usefulness is limited at least in part due to difficulties associated with accurately simulating user input entered at input devices.

For example, it may be difficult to accurately represent user input, such as, for example, a combination of screen location and button press timing resulting from user control of a mouse, to a user interface. Even if user input is delivered to a user interface through a testing program, there is typically a high degree of false positives. These false positives result in part from an inability of testing programs to differentiate between errors interacting with the user interface and errors revealed in the underlying application functionality.

Further, for some types of application functionality, receiving user input at a user interface is the only feasible way to invoke the application functionality. Thus, testing these types of application functionality is typically limited to inefficient manual testing by human testers.

Additionally, functionality invoked through a user interface is typically not directly accessible other applications. That is, it is difficult, if not impossible, for one application to programmatically invoke application functionality of another application when that functionality is typically invoked through input received at a user interface. For example, similar to test inputs, it can be programmatically difficult to simulate manually entered input data to invoke user interface based functionality in another application in a desired manner.

### BRIEF SUMMARY

The present invention extends to methods, systems, and computer program products for controlling applications through inter-process communication. In some embodiments, an application is configured such that application can be controlled through inter-process communication. A computer system instantiates an application within an application process space at the computer system. Instantiation of the application includes making application program interfaces of the application accessible to other software components running within the application process space. Instantiation of the application also includes instantiating an application extension component within the application process space. The application extension component is configured in accordance with an extensibility model for the application.

Instantiation of the application extension component includes instantiating an inter-process communication component within the application process space. The inter-process communication component is configured to participate in inter-process communication with software components external to the application process space using inter-process communication protocol. The inter-process communication component receives incoming inter-process communication from and sends outgoing inter-process communication to external software components. Incoming inter-process communication represents an application program interface call from external software components. Outgoing inter-process communication represents application program interface results.

Thus, the application extension component can be further configured to receive incoming inter-process communication from the inter-process communication component and convert the incoming inter-process communication into input data formatted for compatibility with an application program interface of the application. The application extension component can then call the application program interface with the formatted input data. Further, the application extension component can be configured to receive output data from the application program interface and convert the received output data into outgoing inter-process communication. The application extension component can then send the outgoing inter-process communication to the inter-process communication component.

In other embodiments, an application is controlled through inter-process communication. An inter-process communication component receives inter-process communication from a software component external to an application process space. The incoming inter-process communication represents a call to application program interface of the application. An application extension component converts the incoming inter-process communication into input data formatted for compatibility with an application program interface of the application.

The application extension component calls the application program interface with the formatted input data to programmatically invoke the functionality of the application extension component. Accordingly, the application program interface can be invoked without having to interact with a user-interface for the application. The application extension component can subsequently receive output data from the application program interface and convert the received output data into outgoing inter-process communication. The application extension component can then send the outgoing inter-process communication to the inter-process communication component.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an example computer architecture that facilitates configuring an application to be controlled through inter-process communication.

FIG. 1B illustrates an example computer architecture that facilitates controlling an application through inter-process communication.

FIG. 2 illustrates a flow chart of an example method for configuring an application to be controlled through inter-process communication.

FIG. 3 illustrates a flow chart of an example method for controlling an application through inter-process communication.

FIG. 4 illustrates an example computer architecture that facilitates testing an application.

FIG. 5 illustrates an example computer architecture that facilitates application interoperation.

FIG. 6 illustrates an example computer architecture that facilitates application integration.

### DETAILED DESCRIPTION

The present invention extends to methods, systems, and computer program products for controlling applications through inter-process communication. In some embodiments, an application is configured such that application can be controlled through inter-process communication. A computer system instantiates an application within an application process space at the computer system. Instantiation of the application includes making application program interfaces of the application accessible to other software components running within the application process space. Instantiation of the application also includes instantiating an application extension component within the application process space. The application extension component is configured in accordance with an extensibility model for the application.

Instantiation of the application extension component includes instantiating an inter-process communication component within the application process space. The inter-process communication component is configured to participate in inter-process communication with software components external to the application process space using inter-process communication protocol. The inter-process communication component receives incoming inter-process communication from and sends outgoing inter-process communication to external software components. Incoming inter-process communication represents an application program interface call from external software components. Outgoing inter-process communication represents application program interface results.

Thus, the application extension component can be further configured to receive incoming inter-process communication from the inter-process communication component and convert the incoming inter-process communication into input data formatted for compatibility with an application program interface of the application. The application extension component can then call the application program interface with the formatted input data. Further, the application extension component can be configured to receive output data from the application program interface and convert the received output data into outgoing inter-process communication. The application extension component can then send the outgoing inter-process communication to the inter-process communication component.

In other embodiments, an application is controlled through inter-process communication. An inter-process communication component receives inter-process communication from a software component external to an application process space. The incoming inter-process communication represents a call to application program interface of the application. An application extension component converts the incoming inter-process communication into input data formatted for compatibility with an application program interface of the application.

The application extension component calls the application program interface with the formatted input data to programmatically invoke the functionality of the application extension component. Accordingly, the application program interface can be invoked without having to interact with a user-interface for the application. The application extension component can subsequently receive output data from the application program interface and convert the received output data into outgoing inter-process communication. The application extension component can then send the outgoing inter-process communication to the inter-process communication component.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Within this description and the following claims, a “non-scriptable application” is defined as an application that natively lacks the functionality to process scripts.

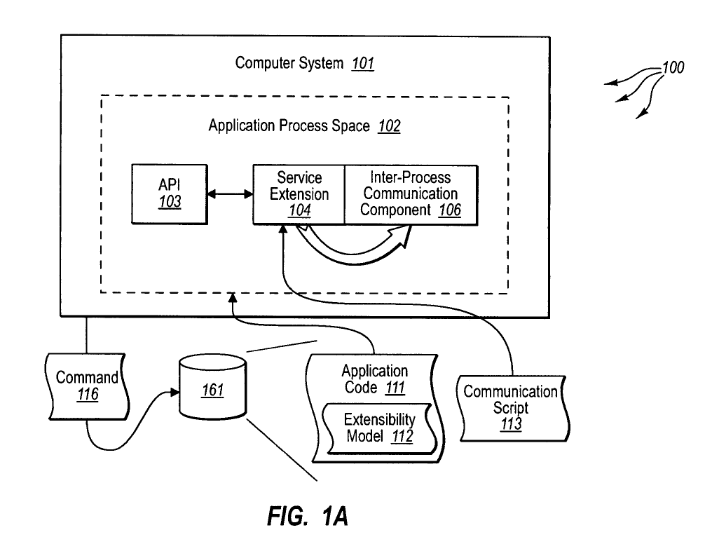

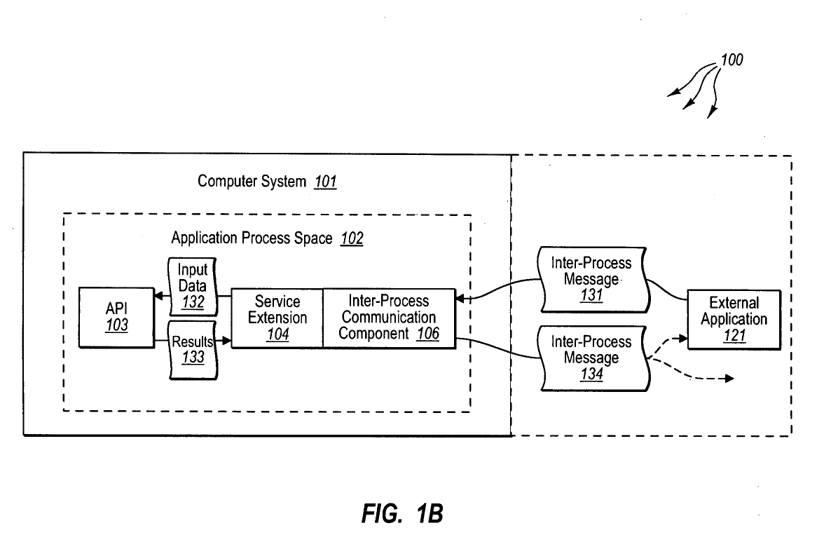

FIG. 1A illustrates an example computer architecture 100 that facilitates configuring an application to be controlled through inter-process communication. Referring to FIG. 1A, computer architecture 100 includes computer system computer system 101 and storage device 161. Computer system 101 can be connected to other computer systems over (or be part of) a network, such as, for example, a Local Area Network (“LAN”), a Wide Area Network (“WAN”), and even the Internet. Accordingly, computer system 101 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Generally, computer system 101 can execute applications by loading applications into system memory. Computer system 101 can receive a user entered or programmatically entered command to activate or “run” an application. In response, the application can be loaded from storage device 161 into an allocated portion of system memory, such as, for example, an application process space. A user can then interact with the application through a user-interface and/or other applications can interact with the application programmatically.

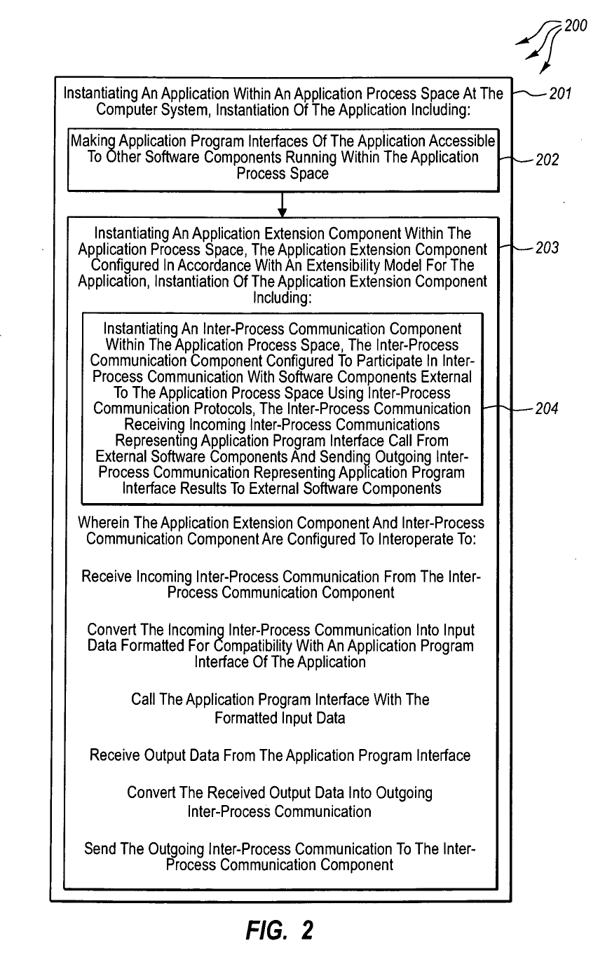

FIG. 2 illustrates a flow chart of an example method 200 for configuring an application to be controlled through inter-process communication. Method 200 will be described with respect to the components and data in FIG. 1A.

Method 200 includes an act of instantiating an application within an application process space at the computer system (act 201). For example, computer system 101 instantiate application program space 102. Computer system 101 can send command 116 to storage device 161 to cause application code 111 to load into application process space 102.

Instantiating the application includes an act of making application program interfaces of the application accessible to other software components running within the application process space (act 202). For example, computer system 101 can make APIs 103 available to other software components running in application program space 102. For example, computer system 101 can make user-interface APIs programmatically available to other software components in application program space 102.

Instantiating the application includes an act of instantiating an application extension component within the application process space, the application extension component configured in accordance with an extensibility model for the application (act 203). For example, computer system 101 can instantiate service extension 104 within application process space 102. Service extension 104 can be instantiated in accordance with extensibility model 112. Service extension 104 can be configured to execute scripts to implement additional functionality within application process space 102. Thus, when application code 111 does not natively include instructions for script processing, the functionality can be added through service extension 104.

Instantiation of the application extension component includes an act of instantiating an inter-process communication component within the application process space, the inter-process communication component configured to participate in inter-process communication with software components external to the application process space using inter-process communication protocols, the inter-process communication receiving incoming inter-process communication representing application program interface calls from external software components and sending outgoing inter-process communication representing application program interface results to external software components (act 204.) For example, service extension 104 can process communication script 113 to instantiate inter-process communication component 106 within application process space 102.

Communication script 113 can define a communication endpoint (e.g., message contract, etc.) for participating in inter-process and/or network-based communication. For example, communication script 113 can define inter-process communication via sockets (e.g., a combination of an IP address and port number) and/or pipes (anonymous or named). In some embodiments, pipes and sockets are interconnected to one another to facilitate inter-process communication. As such, inter-process communication component 106 is configured to participate in inter-process communication with software components external to application process

A programming framework, such as, for example, Windows Communication Foundation (“WCF”) can be used to build applications that inter-communicate. The programming framework can provide various communication programming models for implementing Web services, remoting, transaction communications, asynchronous communications, etc. Accordingly, script 113 can be configured to provide these types of communication services. For example, inter-process communication component 106 can present service extension 104 as Web service. Thus, external applications configured for Web based communication can interoperate with service extension 104.

In some embodiments, inter-process communication component 106 participates in inter-process communication with other applications at computer system 101 running outside of application process space 102. For example, input to and output from inter-process communication 106 can be piped between other applications at computer system 101. In other embodiments, inter-process communication component 106 participates in inter-process communication with other applications running external to computer system 101. For example, inter-process communication component 106 can participate in IP based communication over a network.

Accordingly, inter-process communication component 106 can receive incoming inter-process communication representing application program interface call from external software components. For example, inter-process communication component 106 can receive local and/or remote (e.g., network-based) inter-process communication representing a call to APIs 103. Inter-process communication component 106 can also send outgoing inter-process communication representing application program interface results to external software components. For example, inter-process communication component 106 can send local and/or remote (e.g., network-based) inter-process communication representing results of a call to APIs 103.

As such, service extension 104 and inter-process communication component 106 can interoperate to call an API and return results from an API. Service extension 104 can be further configured to receive incoming inter-process communication from the inter-process communication component 106 and convert the incoming inter-process communication into input data formatted for compatibility with an application program interface of the application. For example, service extension 104 can receive incoming inter-process communication and convert the incoming inter-process communication into input data compatible with APIs 103. Service extension 104 is also configured to call the application program interface with the formatted input data.

Further, service extension 104 is configured to receive output data from the application program interface. Service extension 104 and inter-process communication component 106 are configured to interoperate to convert the received output data into outgoing inter-process communication. For example, the results of a call to APIs 103 can be converted into outgoing inter-process communication. Inter-process communication component 106 is configured to send the outgoing inter-process communication to the inter-process communication component.

FIG. 1B illustrates another view of example computer architecture 100 that facilitates controlling an application through inter-process communication. As depicted, computer architecture includes computer system 101 and external application 121. Computer system 101 and external application 121 can be connected to one another via a system bus of computer system 101. That is, external application 121 can be another application at computer system 101 that is running outside of application process space 102.

Alternately, computer system 101 and external application 121 can be connected to one another and connected to other computer systems over (or be part of) a network, such as, for example, a Local Area Network (“LAN”), a Wide Area Network (“WAN”), and even the Internet. That is, external application 121 is running external to computer system 101. Accordingly, computer system 101 and external application 121 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Within FIG. 1B, service extension 104 can include a data converter (not shown). The data converter is configured to convert incoming inter-process communication into input data for calling API 103 and to convert output data from API 103 into outgoing inter-process communication.

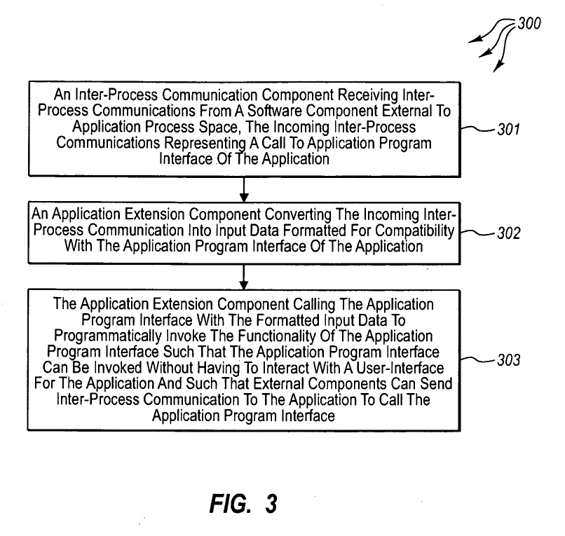

FIG. 3 illustrates a flow chart of an example method 300 for controlling an application through inter-process communication. Method 300 will be described with respect to the components and data in FIG. 1B.

Method 300 includes an act an inter-process communication component receiving inter-process communications from a software component external to application process space, the incoming inter-process communications representing a call to an application program interface of the application (act 301). For example, inter-process communication component 106 can receive inter-process message 131 from external application 121. Inter-process message 131 can be received via sockets and/or pipes from external application 121. In some embodiments, inter-process message 131 is an IP-based message received over a network. Inter-process message 131 can contain information directed to API 103.

Method 300 includes an act of the application extension component converting the incoming inter-process communication into input data formatted for compatibility with the application program interface of the application (act 302). For example, a data converter in service extension 104 can convert inter-process message 131 into input data 132 for calling API 103. Method 300 includes an act of the application extension component calling the application program interface with the formatted input data to programmatically invoke the functionality of the application extension component such that the application program interface can be invoked without having to interact with the user-interface for the application (act 303). For example, service extension 104 can call API 103 with input data 132 to programmatically invoke the functionality of API 103. Accordingly, API 103 can be invoked without (e.g., a user) having to interact with a user-interface.

In some embodiments, API 103 returns results of interest to a calling external application or of interest to some other external application. For example, API 103 can return results 133. A data converter in service extension 104 can convert results 133 into information for inclusion in an inter-process message. The information can be included in inter-process message 134. Inter-process communication component 106 can then send inter-process message 134 to an interested external application. For example, inter-process communication component 106 can send inter-process message 134 back to external application 121. Alternately, inter-process communication component 106 can send inter-process message 134 to some other external application.

Accordingly, embodiments of the invention can be used to add a wide range of scriptable functionality to otherwise non-scriptable applications. For example, embodiments of the invention can be used to test applications, facilitate interoperation between applications, and integrate applications with one another.

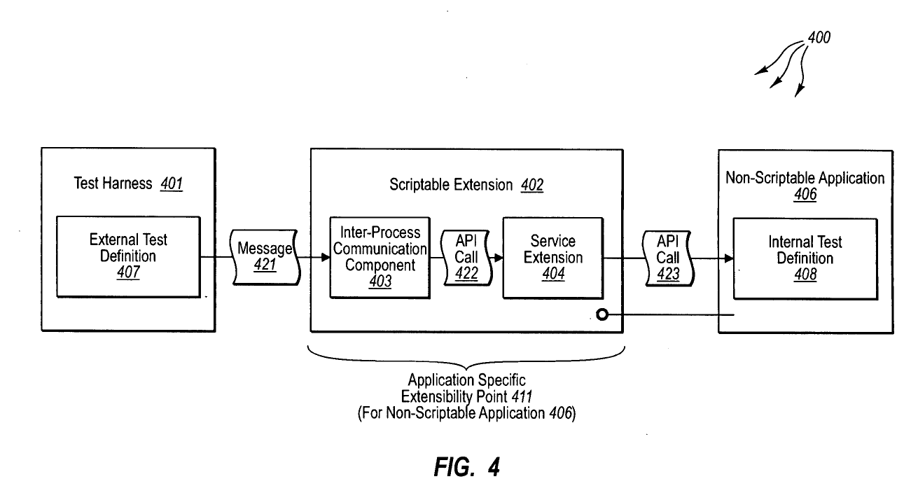

FIG. 4 illustrates an example computer architecture 400 that facilitates testing an application. As depicted, computer architecture 400 includes test harness 401, scriptable extension 402, and non-scriptable application 406. Scriptable extension 402 represents application specific extensibility point 411, an application specific extensibility point for non-scriptable application 406. Generally, inter-process communication component 403 a service interface to test harness 401 for providing automation commands to test non-scriptable application 406.

Test harness 401 can send messages including data form external test harness 407. For example, test harness 401 can send message 421 that includes data form external test definition 407. Inter-process communication component 403 can receive message 421. Inter-process communication component 403 can convert message 421 into API call 422 to service extension 404. Service extension 404 receives API call 422 and converts API call 422 into API call 423. Internal test definition 408 receives API call 423.

Internal test definition 408 implements a test in accordance with the data from external test definition 407. The implemented test can be directed to testing a specified portion of non-scriptable application 406. For example, the test can be directed to functionality that is otherwise only testable via interaction with the user-interface for non-scriptable application 406. As such, portions of an application that otherwise require user interface interaction to execute can be programmatically tested via inter-process communication. Test results can be returned back to test harness 401 (or other some external application) for analysis and/or evaluation. Accordingly, an external test harness can be used to trigger an internal test definition of a non-scriptable application

In some embodiments, the native extensibility model of an application is used to create an extension that is published as a WCF service. The interface of the WCF service is based on testing needs. The implementation of the WCF service bridges external commands by executing the automation hooks provided by the application. An external test harness connects to the published service to drive the testing of the application and/or extensions.

At times, an application extension needs to be tested while hosted inside of the extensible end-user application that it extends. As such, another extension is created that hosts a service via WCF. Client code to connect to the WCF service is written as a test in an existing external test harness. The tests for the original extension are written as the implementation of the WCF service.

When a test pass is executed via the external test harness, the external test harness test implementation launches the extensible end-user application, instructing it to load the WCF service extension (e.g. by command line, or previous configuration). When the service comes up, the external test connects to the service and instructs it to run the internal test. The internal test has access to all of the exposed APIs of the extensible application. The test reports results back either synchronously in the results of the service request or asynchronously using a WCF service exposed by the external test.

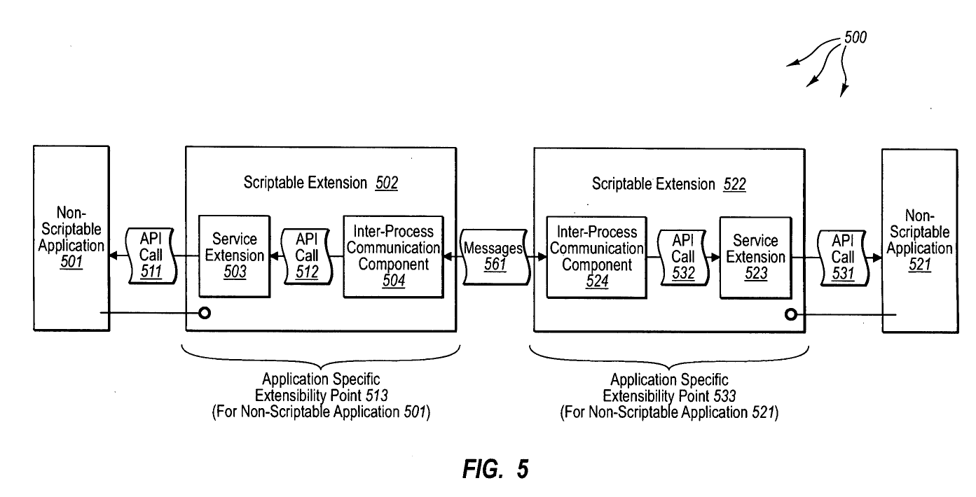

FIG. 5 illustrates an example computer architecture 500 that facilitates application interoperation. As depicted, computer architecture 500 includes test and non-scriptable application 501 (i.e., application 501 is a test application and also a non-scriptable application), scriptable extension 502, and non-scriptable application 521. Scriptable extension 502 represents application specific extensibility point 513, an application specific extensibility point for non-scriptable application 501. Likewise, scriptable extension 522 represents application specific extensibility point 533, an application specific extensibility point for non-scriptable application 521.

Inter-process communication components 504 and 524 can exchange messages 561. Inter-process communication component 504 can receive a message and convert the message into API call 512 to service extension 503. Service extension 503 can receive API call 512 and convert API call 512 into API call 511. API call 511 can invoke functionality of non-scriptable application 501. Results of API call 5 11 can be returned back to inter-process communication component 524.

Similarly, inter-process communication component 524 can receive a message and convert the message into API call 532 to service extension 523. Service extension 523 can receive API call 532 and convert API call 532 into API call 531. API call 531 can invoke functionality of non-scriptable application 521. Results of API call 531 can be returned back to inter-process communication component 504.

As such, non-scriptable applications 501 and 502 can interoperate, potentially in a cooperative manner, to perform various work. For example, non-scriptable application 501 can call non-scriptable application 521 to perform functionally that non-scriptable application 501 lacks or vice versa. Accordingly, two applications that are not otherwise designed to communicate with one another can communicate with one another through scriptable extensions.

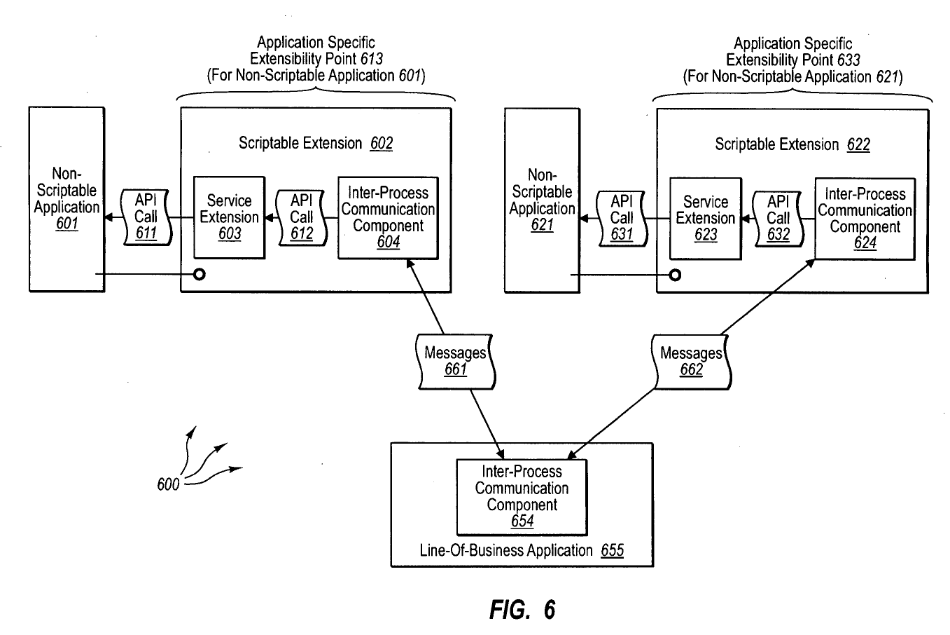

FIG. 6 illustrates an example computer architecture 600 that facilitates application integration. As depicted, computer architecture 600 includes test and non-scriptable application 601, scriptable extension 602, non-scriptable application 621, line of business application 655, and inter-process communication component 654. Scriptable extension 602 represents application specific extensibility point 613, an application specific extensibility point for non-scriptable application 601. Likewise, scriptable extension 622 represents application specific extensibility point 633, an application specific extensibility point for non-scriptable application 621.

Inter-process communication components 604 and 654 can exchange messages 661. Inter-process communication component 604 can receive a message and convert the message into API call 612 to service extension 603. Service extension 603 can receive API call 612 and convert API call 612 into API call 611. API call 611 can invoke functionality of non-scriptable application 601. Results of API call 611 can be returned back to inter-process communication component 654.

Similarly, inter-process communication components 624 and 654 can exchange messages 662. Inter-process communication component 624 can receive a message and convert the message into API call 632 to service extension 623. Service extension 623 can receive API call 632 and convert API call 632 into API call 631. API call 631 can invoke functionality of non-scriptable application 621. Results of API call 631 can be returned back to inter-process communication component 654.

Line of business application 655 can integrate messages received from inter-process communication components 604 and 624 to perform various work. Line of business application 655 can also pass messages received from inter-process communication components 604 to inter-process communication components 624 and vice version. As such, line of business application 655 can also integrate functionality of non-scriptable application 601 with functionality of non-scriptable application 621 and vice versa to perform various work.

Thus, non-scriptable applications can be arranged and connected in a variety of ways with each other and with other Web based applications to provide distributed work environments. For example, a plurality of non-scriptable applications can be represented as Web services that are callable by other Web based applications (or even other extended non-scriptable applications).

Accordingly, applications can be extended with application specific extensibility points. The application specific extensibility points permit applications that natively lack inter-process communication capabilities to participate in inter-process communication. Application specific extensibility points can provide an application with a Web based interface thereby making the functionality of the application available to other Web services and other extended applications. Application specific extensibility points can be used to extend the functionality of applications to interoperate and be integrated with other Web services and other extended applications. In some embodiments, specific extensibility points are used to programmatically test application functionality that can otherwise only be activated through interaction with an application's user-interface

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system, a method for configuring an application to be controlled through inter-process communication, the method comprising
an act of instantiating an application within an application process space at the computer system, instantiation of the application including:
an act of making application program interfaces of the application accessible to other software components running within the application process space;
an act of instantiating an application extension component within the application process space, the application extension component configured in accordance with an extensibility model for the application, instantiation of the application extension component including:
an act of instantiating an inter-process communication component within the application process space, the inter-process communication component configured to participate in inter-process communication with software components external to the application process space using inter-process communication protocols, the inter-process communication receiving incoming inter-process communications representing application program interface call from external software components and sending outgoing inter-process communication representing application program interface results to external software components;
wherein the application extension component is configured to:
receive incoming inter-process communication from the inter-process communication component;
convert the incoming inter-process communication into input data formatted for compatibility with an application program interface of the application;
call the application program interface with the formatted input data;
receive output data from the application program interface;
convert the received output data into outgoing inter-process communication; and
send the outgoing inter-process communication to the inter-process communication component.

2. The method as recited in claim 1, wherein the act of instantiating an application within an application process space at the computer system comprises an act of receiving a programmatic command to instantiate the application.

3. The method as recited in claim 1, wherein the act of instantiating an application within an application process space at the computer system comprises an act of instantiating a non-scriptable application.

4. The method as recited in claim 1, wherein the act of instantiating an application extension component comprises an act of instantiating an application extension component that is configured to run scripts.

5. The method as recited in claim 1, wherein the act of instantiating an inter-process communication component within the application process space comprises an act of the application extension component executing a script.

6. The method as recited in claim 1, wherein the act of instantiating an inter-process communication component within the application process space comprises an act of the instantiating an inter-process communication component that provides a Web service interface for the application extension component.

7. The method as recited in claim 1, wherein the act of instantiating an inter-process communication component comprises an act of instantiating an inter-process communication component that is configured to participate in network communication.

8. The method as recited in claim 1, wherein the act of instantiating an inter-process communication component comprises an act of instantiating an inter-process communication component that is configured to communicate using at least one of pipes and sockets.

9. The method as recited in claim 1, wherein the act of instantiating an inter-process communication component within the application process space comprises an act of the instantiating an inter-process communication component that is configured to receive commands from an external test harness, the commands for programmatically testing a portion of the application that is otherwise only testable through interaction with the application's user-interface.

10. The method as recited in claim 1, wherein the act of instantiating an inter-process communication component within the application process space comprises an act of instantiating an inter-process communication component that is configured to interoperate with inter-process communication components of one or more non-scriptable applications.

11. At a computer system including a non-scriptable application running in an application process space, the application including application program interfaces, an application extension component, and an inter-process communication module, the inter-process communication component configured to participate in inter-process communication with other components external the application process space using an inter-process communication protocol, the application extension component configured to translate between inter-process communication and application program interface calls, the application also including a user-interface permitting user interaction with the application, a method for controlling the application through inter-process communication, the method comprising
an act of the inter-process communication component receiving inter-process communication from a software component external to application process space, the incoming inter-process communications representing a call to application program interface of the application;
an act of the application extension component converting the incoming inter-process communication into input data formatted for compatibility with the application program interface of the application; and
an act of application extension component calling the application program interface with the formatted input data to programmatically invoke the functionality of the application extension component such that the application program interface can be invoked without having to interact with the user-interface for the application.

12. The method as recited in claim 11, further comprising:
an act of the application extension receiving results from the application program interface; and
an act of the application extension converting the results to outgoing inter-process communication;

13. The method as recited in claim 12, further comprising an act of sending the outgoing inter-process communication to the external software component.

14. The method as recited in claim 12, further comprising an act of sending the outgoing inter-process communication to a second different external software component to interoperate with the second different external component.

15. The method as recited in claim 12, further comprising an act of sending the outgoing inter-process communication to a third different external software component, the third different external component integrating the functionality of plurality of non-scriptable applications.

16. The method as recited in claim 11, wherein the act of the inter-process communication component receiving inter-process communication comprises an act of the inter-process communication component receiving inter-process communication via at least one of a socket and a pipe.

17. The method as recited in claim 11, wherein the act of the inter-process communication component receiving inter-process communication comprises an act of the inter-process communication component receiving commands from an external test harness, the commands for programmatically testing a portion of the application that is otherwise only testable through interaction with the application's user-interface.

18. The method as recited in claim 11, wherein the act of the inter-process communication component receiving inter-process communication comprises an act of the inter-process communication component receiving inter-process communication from a Web service that desires to utilize the functionality provided by application program interface.

19. A computer system, the computer system comprising:
one or more processors;
system memory;
one or more physical storage media, the physical storage media having stored thereon computer-executable instructions representing an application specific extensibility point for interoperating with an external test harness that is external to the computer system, the application specific extensibility point for testing a portion of a non-scriptable application that is otherwise only testable through interaction with the application's user-interface, application specific extensibility point configured to:
instantiate a service extension in the application process space of the non-scriptable application;
execute a script to load an inter-process communication component into the application process space of the non-scriptable application, the inter-process communication component configured to communicate with the external test harness using inter-process communication;
receive commands from the external test harness via inter-process network communication, the commands for programmatically testing a portion of the non-scriptable application that is otherwise only testable through interaction with the non-scriptable application's user-interface; and
call APIs of the non-scriptable application to invoke an internal test definition to test portions of the non-scriptable application in accordance with the commands received from the external test harness.

20. The system as recited in claim 19, wherein the inter-process communication component provides a Web service interface for the non-scriptable application such that a Web service test harness can be used to test the non-scriptable application.
